(19) United States
(12) Patent Application Publication
(10) Pub. No.: US 2007/0215709 A1
(43) Pub. Date: Sep. 20, 2007

(54) RFID SENSOR

(75) Inventors: Paul F. Baude, Maplewood, MN (US); Steven D. Theiss, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/276,805

(22) Filed: Mar. 15, 2006

(51) Int. Cl. G06K 19/06; G06K 7/08

(52) U.S. Cl. 235/492; 235/451

(57) ABSTRACT

An RFID-based sensor includes a plurality of discrete sensor elements. Each sensor element changes conductivity state based on exposure of the sensor to a physical condition. An RFID circuit coupled to the plurality of sensor elements transmits a code corresponding to the conductivity states of the of sensor elements. The code may comprise the identification code of the RFID circuit. A level of exposure to the condition or a duration of exposure to the condition may be indicated by the code. Each of the sensor elements may be sensitive to a distinct condition and the code may indicate exposure to each of the distinct conditions. The code may indicate a prior exposure to a condition or may indicate a present exposure to the condition.

### TECHNICAL FIELD

The present invention is related to the radio frequency identification (RFID) devices, and more particularly, to sensors used in conjunction with radio frequency identification devices.

### BACKGROUND

Radio frequency identification (RFID) tags are small electronic devices that have been used to detect the presence or movement of articles of interest. RFID tags are frequently used in various applications, such as in manufacturing to track the progress of a workpiece through a manufacturing process, in retail applications to deter theft of merchandise, and in traffic applications to detect movement of vehicles through a tollway.

The presence of an article bearing an RFID tag may be electronically detected by wirelessly interrogating the RFID tag, either intermittently or continuously. The RFID tag typically stores an identification (ID) code. When interrogated by an RFID tag reader, the RFID tag wirelessly transmits its ID code to the RFID tag reader. The code transmitted by the RFID tag to the RFID tag reader indicates the presence and identification of the article bearing the RFID tag.

RFID tags may include a battery or other independent power source, or they may acquire power from the RF signal transmitted by the external RFID tag reader. RFID tags without independent power sources are particularly small and inexpensive, making them very cost effective for tracking a large number of moving objects.

Acquiring information from RFID tags about an article, in addition to presence and identification information, is desirable. The present invention fulfils these and other needs, and offers other advantages over the prior art.

### SUMMARY

Embodiments of the present invention are directed to an RFID sensor, RFID sensor systems, and RFID sensing methods.

One embodiment of the invention involves an RFID-based sensor that comprises a plurality of discrete sensor elements. Each sensor element is configured to change conductivity state based on exposure of the sensor element to a physical condition. An RFID circuit is coupled to the plurality of sensor elements and is configured to transmit a code corresponding to the conductivity state of the plurality of sensor elements. In some configurations, the code may comprise the identification code of the RFID device.

In various implementations, the code corresponding to the conductivity state of the sensor elements may indicate a level of exposure to the condition or a duration of exposure to the condition. Each of the plurality of sensor elements may be sensitive to a distinct condition and the code may indicate exposure to each of the distinct conditions. According to various approaches, the code may indicate a prior exposure to the environmental condition, or may indicate a present exposure to the condition

In one example, a first sensor element of the plurality of discrete sensor elements may change conductivity state based on exposure to a first gas and a second sensor element of the plurality of discrete sensor elements may change conductivity state based on exposure to a second gas. The code transmitted by the RFID sensor may indicate exposure to the first and/or second gases.

For example, the sensor elements may comprise passive conductor elements configured to change from a first conductivity state associated with a first logic level to a second conductivity state associated with a second logic level due to exposure to the physical condition. Changes in the conductivity state of a sensor element may be caused by an oxidation process, a corrosion process, a mechanical process, a chemical process, a thermal process, or by any other processes that cause the sensor element to change from a first conductivity state to a second conductivity state. In some configurations, the state change may occur due to exposure to an electric field, a magnetic field or a gravitational field, for example.

The RFID sensor may include one or more thin film circuit components. The RFID circuitry may be powered by AC or DC power. The RFID circuitry may include an independent power source or may acquire power from the RF energy transmitted from an external RF source.

Another embodiment is directed to an RFID system. The system includes a plurality of discrete sensor elements, each sensor element configured to change conductivity state based on exposure of the sensor element to a physical condition. An RFID circuit is coupled to the plurality of sensor elements and is configured to transmit a code corresponding to the conductivity state of the plurality of sensor elements. An RFID interrogator is configured to receive the code transmitted from the RFID circuit.

A further embodiment of the invention is directed to an RFID sensing method. The method involves sensing a conductivity state of a plurality of sensor elements. Each sensor element is configured to change conductivity state based on exposure of the sensor element to a physical condition. A code is transmitted via an RFID circuit, wherein the code corresponds to the conductivity state of the plurality of sensor elements.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### DESCRIPTION OF THE DRAWINGS

FIG. 1 is a block diagram of an RFID sensor in accordance with embodiments of the invention;

FIG. 2A illustrates a sensor comprising a plurality of sensor elements configured to change conductivity state in the presence of an environmental condition in accordance with embodiments of the invention;

FIG. 2B illustrates a circuit for using the sensor in accordance with embodiments of the invention;

FIG. 3 is a circuit diagram illustrating a configuration of the RFID sensor circuitry in accordance with embodiments of the invention;

FIGS. 4A and 4B illustrate a sensor element configured to change conductivity state due to formation of an insulating layer in accordance with embodiments of the invention;

FIGS. 5A and 5B illustrate a sensor element configured to change conductivity state due to temperature in accordance with embodiments of the invention;

FIGS. 6A and 6B illustrate a sensor element configured to change conductivity state due to a change in pressure in accordance with embodiments of the invention;

FIGS. 7A and 7B illustrate a sensor element configured to change conductivity state due to a change in orientation with respect to gravity in accordance with embodiments of the invention;

FIGS. 8A and 8B illustrate a sensor element configured to change conductivity state due to removal of a conductive element in accordance with embodiments of the invention; and

FIGS. 9A and 9B illustrate a time passed sensor in accordance with embodiments of the invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following description of the illustrated embodiments, reference is made to the accompanying drawings that form a part hereof, and in which are shown by way of illustration, various embodiments in which the invention may be practiced. It is to be understood that the embodiments may be utilized and structural changes may be made without departing from the scope of the present invention.

Embodiments of the present invention are directed to methods, devices, and systems involving RFID circuitry used in conjunction with a sensor, denoted herein as an RFID sensor. An RFID sensor of the present invention may be used to detect the presence of an article bearing the RFID sensor and also to acquire additional information about the article. In accordance with various embodiments, the RFID sensor transmits a binary code associated with the present or prior exposure of the RFID sensor to one or more physical conditions. In some implementations, the binary code transmitted by the RFID sensor may indicate the occurrence of one or more events affecting the sensor.

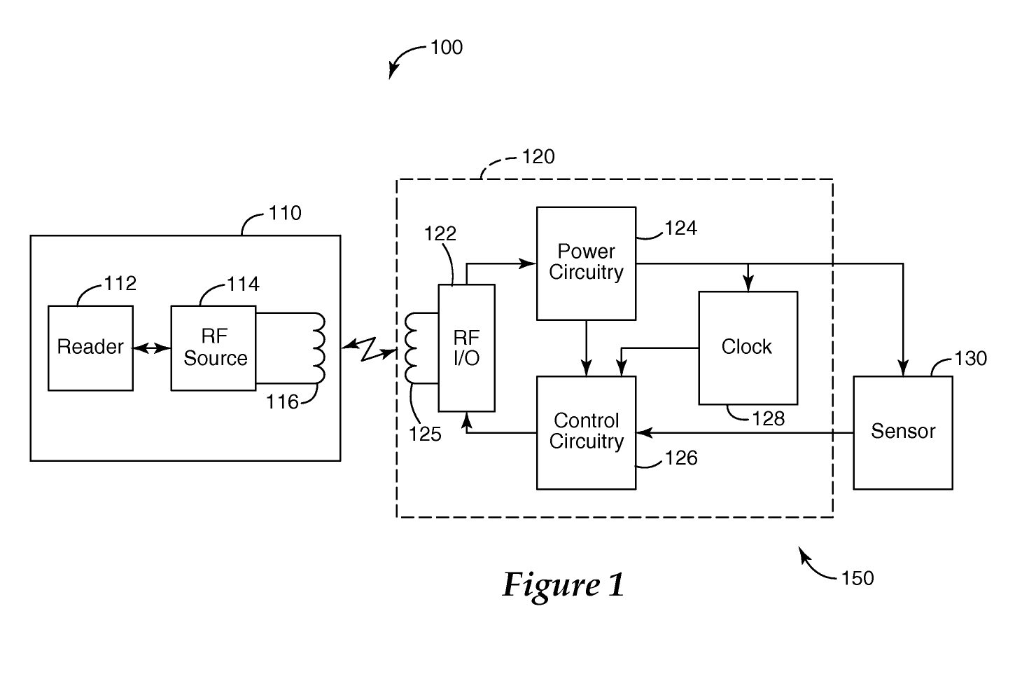

The block diagram of FIG. 1 illustrates an RFID system 100 including an RFID sensor 150 in accordance with embodiments of the invention. The system 100 includes an RFID interrogator 110 and RFID sensor 150 including RFID circuitry 120 and sensor 130. The RFID interrogator 110 includes a radio frequency (RF) source 114 and reader 112. The RF source 114 intermittently or continuously transmits RF energy to the RFID sensor 150. The RF energy transmitted by the RF source 114 may be used to power the RFID sensor 150. If the transmitted RF energy is used to power the RFID sensor 150, the RFID sensor 150 does not require an independent power supply, thus reducing the complexity and/or cost of the RFID sensor 150.

The RFID interrogator 110 includes an inductor 116 that serves as an antenna to transmit RF energy to the RFID sensor 150 and to receive RF signals from the RFID sensor 150. The RFID circuitry 120 includes an inductor 125 used to receive the RF energy from the RFID interrogator 110 and to transmit RF signals from the RFID sensor 150 to the RFID interrogator 110.

If the RFID sensor 150 is powered from the RF energy delivered by the RFID interrogator 110, RFID circuitry 120 includes power circuitry 124 that converts the RF energy received from the RFID interrogator 110 into power useable by other components of the RFID sensor 150, including control circuitry 126, clock 128, and sensor 130. The power circuitry 124 may produce DC or AC power, for example. In alternate embodiments, the power circuitry 124 may include a battery or other power source providing power to the RFID sensor 150 independent from the RFID interrogator 110.

The clock 128 drives the control circuitry 126 to acquire data from the sensor 130 and to output the data to the RFID interrogator 110. The control circuitry 126 may operate to output the data from the sensor 130 to the RFID interrogator 110 as a serial data stream. The data is transmitted from the RFID sensor 150 to the RFID interrogator 110 via the RF input/output circuitry 122 and the inductor 125. The data is received by the RFID interrogator 110 for interpretation by the reader 112.

The RFID sensor 150 may be positioned on an article of interest remote from the RF interrogator 110 so that physical conditions experienced by the article of interest are also experienced and detected by the RFID sensor 150. The term “physical condition” is used herein to denote a physical condition of the ambient surroundings to which the sensor is exposed. For example, physical conditions may include environmental conditions and/or may include field orientation conditions. Environmental conditions include the presence or absence of gas, light, sound, temperature, pressure, moisture, and/or other conditions of the environment. Field orientation conditions include exposure to a field and/or movement with respect to a field, such as a magnetic, electrical, or gravitational field.

In some embodiments, in addition to at least one sensor element that is sensitive to exposure to a physical condition such as those listed above, the sensor 130 may include at least one sensor element that is sensitive to an event or act, such as a human or animal making or breaking the connection made by a sensor element. For example, making or breaking the connection of a sensor element may be caused by an intentional or unintentional act of a human or animal that moves, cuts, or tears the sensor element, or otherwise operates to change the conductivity state of the element.

In accordance with various embodiments, the sensor 130 includes a number of sensor elements configured to change binary state from a first logic state associated with an open circuit or relatively high electrical conductivity condition to a second logic state associated with a closed circuit or relatively low electrical conductivity condition based on the sensed physical conditions or detected events. According to aspects of the invention, each of the sensor elements may comprise a switch or a conductive element made of one or more layers of metal and/or other material, for example.

In one implementation, the binary states of n sensor elements corresponds to an n-bit code. The binary states of the n sensor elements may be detected and transmitted wirelessly to the RF interrogator 110 having a reader 112 that may be used to interpret the n-bit code.

RFID tags generally transmit an identification (ID) code that has been programmed into the device. For example, the ID code of an RFID tag may be programmed by scribing or electrically fusing an ID connection at each of m connection nodes. In some embodiments of the present invention, sensor elements of the sensor 130 may be used in place of one or more of the ID connections. In other embodiments, one or more sensor elements may be used in addition to the ID connections.

Use of the sensor elements in place of the ID connections allows the ID code of the RFID sensor 150 to be determined by events affecting the RFID sensor 150 and/or the present or prior environment of the RFID sensor 150. For example, the code transmitted by the RFID sensor 150 may reflect the time and/or degree of exposure to an environmental condition and/or the time passed since shipment of the RFID sensor 150, and/or other present or prior conditions of environmental and/or field exposure.

In some embodiments, the RFID sensor 150 may incorporate thin film devices or circuit elements. Thin film materials offer a number of manufacturing advantages for fabrication of electronic circuits. Thin film devices may be fabricated on flexible substrates such as thin glass, plastic, polymeric or paper substrates, for example. In addition, thin film materials may be processed using low cost fabrication techniques such as printing, embossing, or shadow masking.

Thin film devices may be formed of inorganic semiconductors such as polycrystalline silicon, amorphous silicon, zinc oxide, and/or cadmium selenide and/or may be formed of organic semiconductors. Thin film transistor-based logic circuitry for RFID applications may be powered by AC power. The use of AC-powered thin film circuitry may substantially reduce the cost and size of an RFID tag by eliminating the need for a rectifier to convert the RF AC signal to DC. The derivation and use of AC power for RFID applications, and circuitry using AC power for implementing RFID devices are described in commonly owned U.S. Patent Application Publications 2004/0119504 and 2005/0134318 which are incorporated herein by reference.

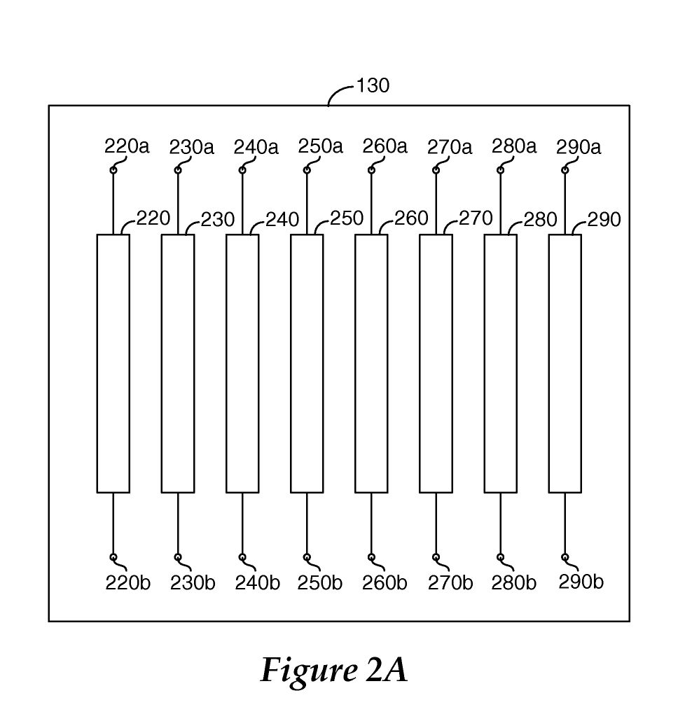

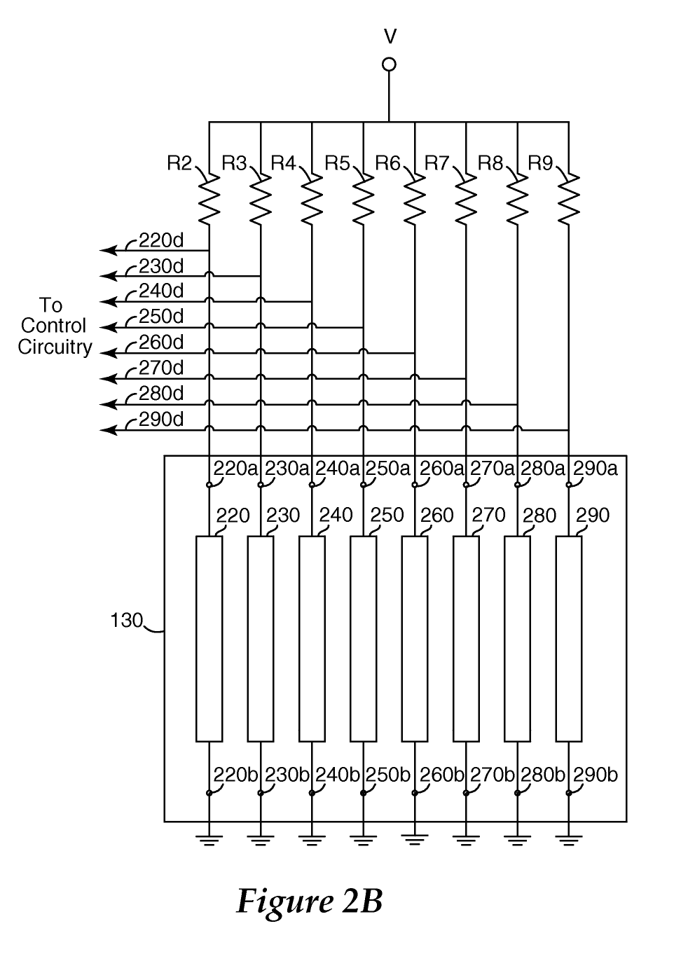

FIG. 2A illustrates in more detail the sensor 130 of FIG. 1. As illustrated in FIG. 2A, sensor 130 comprises a number of discrete sensor elements 220-290. Each sensor element 220-290 is respectively disposed between a first electrical node 220a-290a and a second electrical node 220b-290b. Although the exemplary sensor 130 is depicted as incorporating 8 sensor elements 220-290, more or fewer sensor elements 220-290 may be used.

The sensor elements 220-290 may comprise, for example, conductive strips formed from one or more layers of a metal or other conductive material. The sensor elements 220-290 are configured to change conductive state based on a sensed condition. For example a sensor element 220-290 may change from a first conductive state associated with high conductivity or short circuit to a second conductive state associated with low conductivity or open circuit based on the sensed condition or detected event. Alternatively, a sensor element 220-290 may change from the second conductive state associated with low conductivity to the first conductive state associated with high conductivity based on the sensed condition or detected event. The conductive states of the sensor elements 220-290 may be represented by one-bit binary logic states which can be acquired by accessing the electrical nodes 220a-290a, 220b-290b. The states of the sensor elements 220-290 may be output from the RFID sensor to the RFID interrogator as an n-bit digital code.

FIG. 2B illustrates an exemplary circuit for implementing the sensor 130. The sensor elements 220-290 are coupled to a voltage source, V, through resistors R2-R9 through nodes 220a-290a and are connected to ground through nodes 220b-290b. The control circuitry (not shown) is coupled to the sensor elements 220-290 at nodes 220a-290a through data lines 220d-290d. In this example, the sensor elements 220-290 are initially in a state of high conductivity, shorting nodes 220a-290a to ground, and causing the control circuitry to detect a logical “0” at each of the nodes 220a-290a. Upon exposure to physical conditions, one or more of the sensor elements 220-290 may transition to a state of low conductivity or open circuit, causing the control circuitry to read a logical “1” at the node of the sensor elements having low conductivity. The logical state at nodes 220a-290a provides a 8-bit code that is read by the control circuitry and transmitted to the RFID interrogator.

The change in binary state of the sensor elements may occur due to various processes. For example, the change in conductivity state may occur due to a chemical reaction, such as corrosion or oxidation, a thermal process, a mechanical processes, and/or by any other processes that cause a change in the conductivity of a sensor element. The sensor elements of the RFID sensor of the present invention may be calibrated to indicate a level or duration of exposure to a physical condition. In these implementations the change in conductive state of a sensor element does not occur until the sensor element has been exposed to the environmental condition at the level associated with the calibration level of the sensor element.

In some embodiments, each sensor element is configured to detect the same physical condition or event. In other embodiments, one sensor element may be used to detect a first physical condition or event and another sensor element may be used to detect a second physical condition or event.

In some embodiments, the sensor elements may be used to detect different levels of exposure to a physical condition or the duration of exposure to a physical condition. For example, one sensor element may be configured to detect a first level or duration of exposure to a particular environmental condition and another sensor element may be configured to sense a second level or duration of exposure to the particular environmental condition.

In some embodiments, the sensor elements include metal traces and the change of binary state may be the result of corrosion of the metal traces. In one example, a sensor element may be implemented as a thin metal layer that oxidizes in the presence of oxygen, thus becoming insulating. If a number of sensor elements are formed as metal layers of varying thickness, the sensor may operate as an elapsed time sensor, with each sensor element taking progressively longer to become insulating. In another example, the sensor elements may be configured to detect the presence or level of moisture or of a specific gas. In some implementations, each sensor element may be sensitive to a distinct physical condition. For example, the use of a number of sensor elements, each sensitive to a different type of gas provides an RFID sensor that functions as an “electronic nose.”

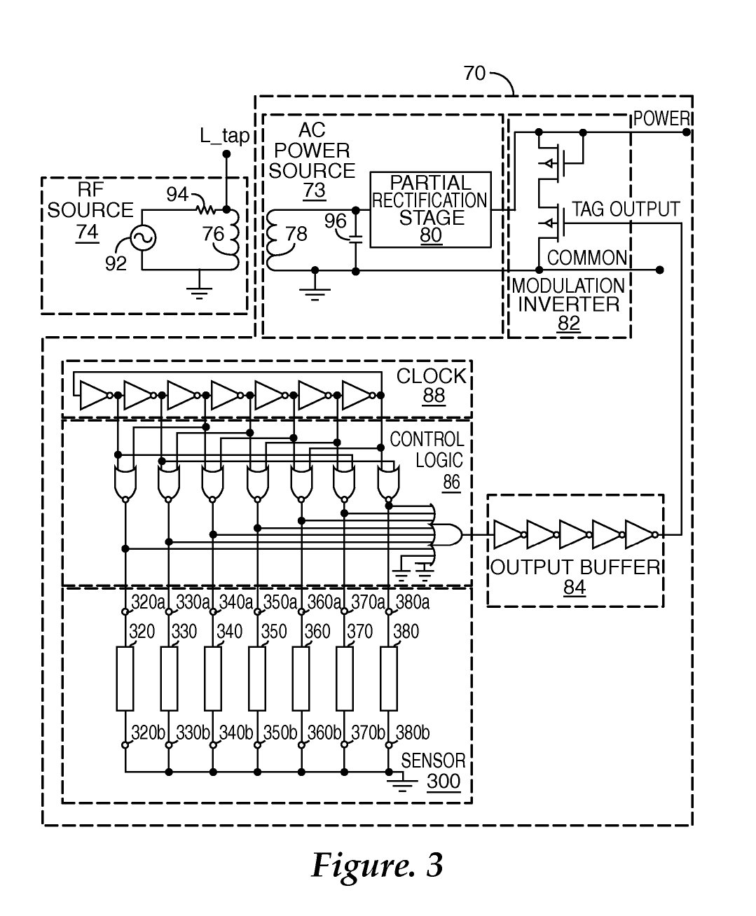

FIG. 3 is a circuit diagram further illustrating a configuration of the RFID sensor. As shown in FIG. 3, the RF source may include an AC generator 92 that transmits an ac output signal via inductor 76. For some applications, AC generator 92 may take the form of a sinusoidal current source with an output of approximately 0 to 5 amps at a frequency of approximately 125 kHz.

Inductors 76 and 78 form a transformer for electromagnetic coupling of RF energy between RF source and RFID sensor 70. Resistor 94 is selected to limit current. A capacitor 96 may be placed in parallel with inductor 78 within power source 73 to form a parallel resonant tank that governs the frequency of the power source according to the equation:
f=1/2π\sqrt{LC},
where L is the inductance of inductor 78 and C is the capacitance of capacitor 96.

With an inductance of 50 μH and a capacitance of 32 nF, inductor 78 and capacitor 96 generate a resonant frequency of approximately 125 KHz. Hence, in this example, the output of ac power source 73 is a sinusoidal waveform with a frequency of approximately 125 kHz. This waveform produced by inductor 78 is partially rectified by partial rectification stage 80 to produce a partially rectified ac power waveform as the output of power source 73. The partially rectified AC power waveform is then applied to clock circuit 88, control logic 86, output buffer 84, and modulation inverter 82 as represented in FIG. 3 by the terminals POWER and COMMON.

FIG. 3 depicts an RFID sensor 70 that carries an n-bit identification code. For ease of illustration, RFID sensor 70 carries a 7-bit identification code specified by conductive elements 320-380 of sensor 330, although the number of bits in the identification code may be less than or greater than 7. In the example of FIG. 3, clock circuit 88 is a ring oscillator formed by a series of seven inverter stages arranged in a feedback loop.

The ring oscillator of FIG. 3 depicts the outputs of two inverters which are applied to a respective NOR gate provided in control logic 86. In this way, seven NOR gates are used to generate a sequence of seven pulses within each clock cycle produced by the ring oscillator. Note that the number of NOR gates in control logic 86 may vary. This arrangement could be extended, in principle, to larger numbers of bits, e.g., n=31, 63 or 127.

The RFID sensor includes sensor 330 having sensor elements 320-380. Sensor elements 320-380 are connected at nodes 320a-380a to respective NOR gate outputs. Sensor elements 320-380 are connected at nodes 320b-380b to ground. If a sensor element 320-380 is in a high conductivity state, the output of the associated NOR gate is coupled via node 320a-380a to ground. If a sensor element 320-380 is in a low conductivity state, the NOR gate output is coupled as one of the inputs to a 7-input OR gate within control logic 86.

For example, consider the situation if the sensor elements 330 and 350 are in a high conductivity state and sensor elements 320, 340, and 360-380 are in a low conductivity state. In this example, the 7-bit identification code “1010111” will be present at nodes 320a-380a.

The sensor elements 320-380 can be made, for example, from metal conductors that extend from the NOR gate outputs to ground and which are initially in a high conductivity state. The one or more sensor elements 320-380 can be configured to transition to the low conductivity state upon exposure to a physical condition, thereby altering the identification code present at nodes 320a-380a based one exposure to the physical condition.

The output of the 7-input OR gate in control logic 86 is applied to a cascade of buffer amplifiers in output buffer 84 to help match the output impedance of the logic circuitry to the input impedance of the modulation inverter 82. Specifically, the signal TAG OUTPUT is applied to the gate of the drive transistor associated with modulation inverter 82. Modulation inverter 82 then modulates the Q of the tank formed by inductor 78 and capacitor 96 to provide amplitude modulation of the carrier signal. In this manner, the received buffer output is conveyed to reader unit so that the reader can read the identification code. In particular, the reader processes the signal received at L_tap via inductor 76.

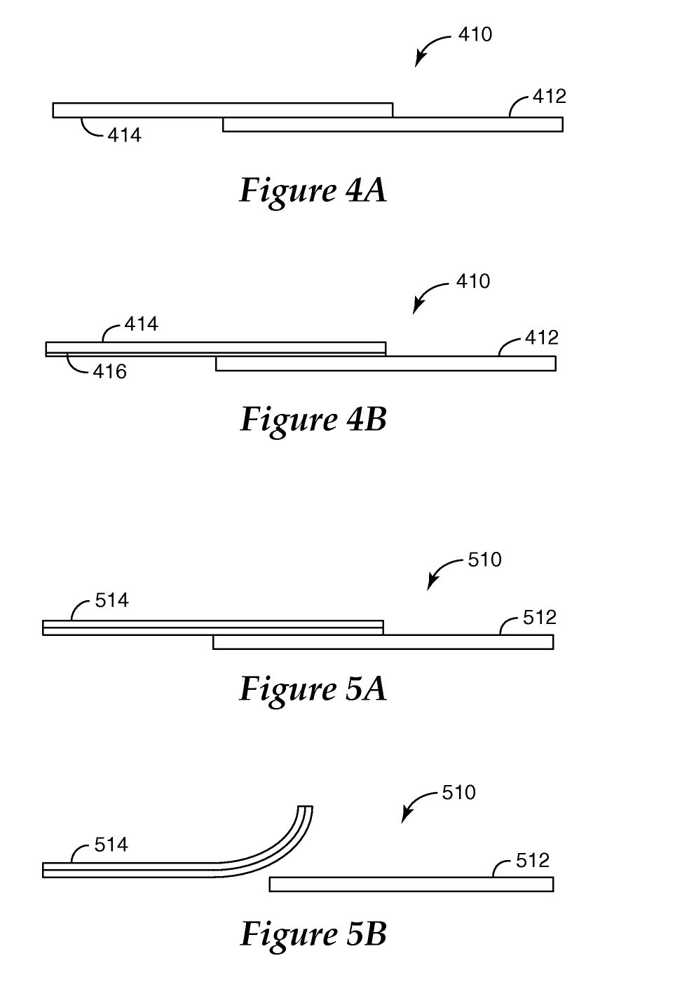

FIGS. 4A-4B illustrates one process causing a transition of a sensor element from a high conductivity state to a low conductivity state based on exposure to a physical condition. FIG. 4A illustrates a sensor element comprising two overlapping conductors 412, 414. In FIG. 4A, the sensor element 410 is in a high conductivity state because the overlapping conductors 412, 414 make electrical contact. FIG. 4B illustrates the sensor element 410 following transition to a low conductivity state due to the formation of an insulating layer 416 between the conductors 412, 414. For example, the sensor element 410 may function as an oxygen sensor, wherein the conductivity state of the sensor element 410 changes due to the formation of an insulating oxidized layer on one or both conductors 412, 414 due to exposure to oxygen.

In some implementations, a sensor element may be calibrated so that the change in conductive state occurs at a particular level or duration of exposure to the physical condition. For example, the material forming a sensor element may be selected to have a certain rate of oxidation, so that the change from the first conductive state to the second conductive state corresponds to a level or duration of oxygen exposure. Calibration of a sensor element, for example, by selection of a particular material used to form the sensor element and/or configuration of the physical dimensions of the sensor element, allows the code transmitted by the RFID sensor to indicate not only exposure to the physical condition, but also the level or duration of the exposure. In addition, multiple sensor elements may be used, each changing conductive state at different levels or durations of exposure. If multiple sensor elements are used in this way, the code transmitted by the RFID sensor indicates a range of exposure to the physical condition. For example, the exposure range may be determined as being greater than or equal to the exposure level associated with the sensor elements that have changed conductivity state, but less than the exposure level associated with the sensor elements that have not yet changed conductivity state. The RFID sensor may be interrogated repeatedly and the codes transmitted by the RFID sensor may be used to track the exposure of the RFID sensor to the physical condition over time.

In some implementations, the physical condition may be temperature and the sensor elements may be selected to change from a first conductive state to a second conductive state based on exposure to a particular temperature. For example, as illustrated in FIGS. 5A and 5B, the sensor element 510 may be configured as a bimetal switch sensitive to temperature changes. In FIGS. 5A and 5B, conductor 514 is formed as a bimetal conductor that flexes at a switching temperature. Alternatively, both of the conductors 512, 514 of the sensor element 510 may include bimetal conductors. The sensor element 510 may be configured to be initially in a low conductivity state associated with a first logic level, with the bimetal switch initially open as illustrated in FIG. 5B, or may be configured to be initially in a high conductivity state associated with a second logic level, with the switch initially closed, as illustrated in FIG. 5A. Exposure to the switching temperature causes movement of the bimetal conductor 514 due to thermal expansion or contraction of the metal resulting in a conductivity state change. For example, if the sensor element 510 is initially in a low conductivity state, as illustrated in FIG. 5B, a decrease in temperature causes the bimetal conductor 514 to contract, and the sensor element 510 transitions to a high conductivity state, as illustrated in FIG. 5A. Alternatively, if initially in a high conductivity state, as illustrated in FIG. 5A, an increase in temperature causes the bimetal conductor 514 to expand, causing the sensor element 510 to transition to the state associated with low conductivity, as illustrated in FIG. 5B. Exposure to the temperature is represented as a change in the logic level output associated with the sensor element.

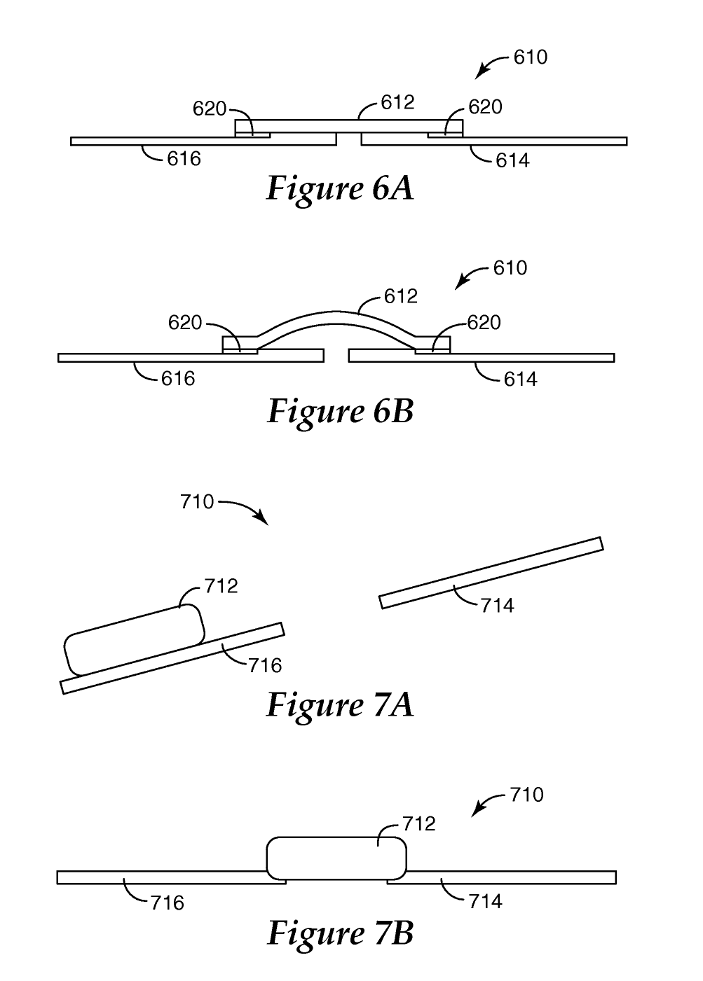

FIGS. 6A and 6B illustrate yet another example of the operation of a sensor element in accordance with embodiments of the invention. In this example, a pressure differential causes movement of one of the sensor element conductors. FIG. 6A illustrates the sensor element 610 in a high conductivity state. A conductive diaphragm 612 is attached via insulators 620 to first and second conductors 614, 616 of the sensor element 610. In the high conductivity state, the conductive diaphragm 612 makes an electrical connection between the first and second conductors 614, 616. The conductive diaphragm 612 remains in contact with the first and second conductors 614, 616 in the absence of a pressure differential. Exposure to a pressure differential causes movement of the pressure sensitive conductor 612, breaking the connection between the first and second conductors 614, 616, and causing the sensor element 610 to transition to the low conductivity state as illustrated in FIG. 6B.

FIGS. 7A and 7B illustrate the operation of a sensor element 710 configured as an orientation or tilt sensor. The sensor element includes first and second conductors 714, 716 and an orientation sensitive conductor 712, e.g., a conductive ball or mercury droplet. Tilting the sensor element 710 causes the orientation sensitive element 712 to move due to the gravitational field, making an electrical connection between the first and second conductors 714, 716. FIGS. 7A and 7B illustrate the sensor element 710 in a low conductivity state and a high conductivity state, respectively.

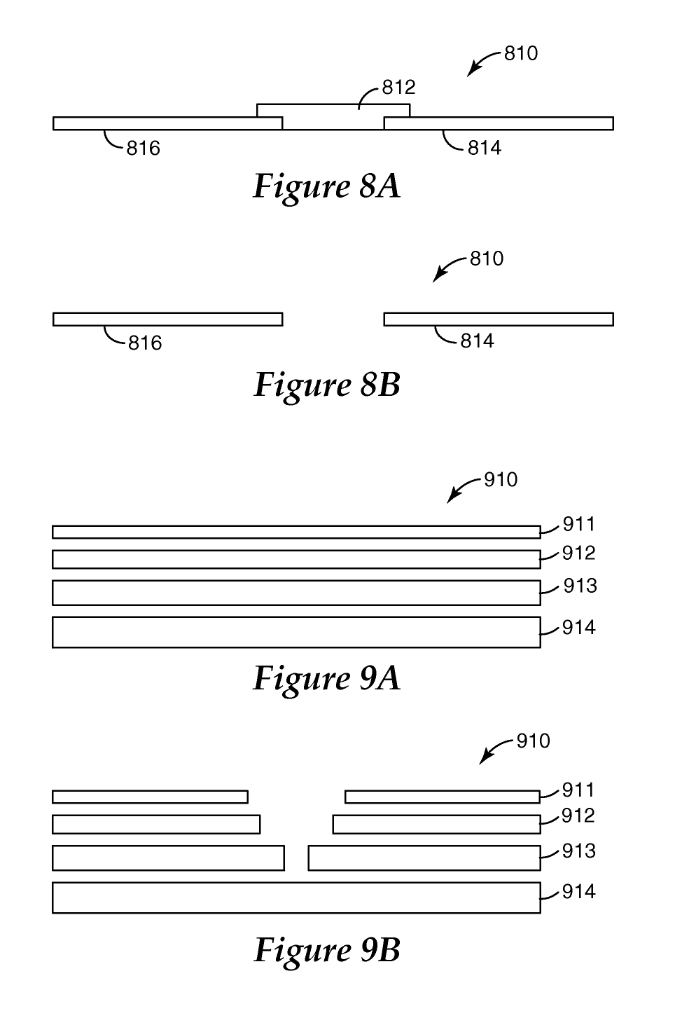

In some implementations, a change in the conductivity state may occur if a conductive substance is removed from the sensor element. As illustrated in 8A, the sensor element 810 may initially include a conductive substance 812 between first and second conductors 814, 816 of the sensor element 810. The conductive substance 812 makes an electrical connection between the first and second conductors 814, 816, causing the sensor element 810 to be in a high conductivity state. The conductive substance 812 may be sensitive to a particular physical condition. Exposure to the condition causes the conductive substance 812 to dissolve or melt, causing a break in the electrical connection between the first and second conductors 814, 816, depicted in FIG. 8B. The removal of the electrical connection between first and second conductors 814, 816 causes the sensor element 810 to transition to a low conductivity state.

In some implementations, a physical condition may cause a temporary change in the conductivity state of a sensor element. In these implementations, a code transmitted by the RFID sensor indicates the present state of the physical condition. In other implementations, exposure to a physical condition may cause a permanent change in the conductivity state of a sensor element. In these configurations, the code indicates previous exposure to the condition.

FIGS. 9A and 9B illustrate a sensor 910 used to implement a time passed detector. Each of the sensor elements 910-914 is sensitive to a progressive level of exposure to a physical condition. In this embodiment, the sensor elements 911-914 are formed of a reactive metal, such as calcium, and have varying widths and thicknesses. For example, the widths and thicknesses of the sensor elements 911-914 increase by an amount that is determined based on the oxidation/corrosion rate of the metal when exposed to air. After the sensor elements 911-914 are exposed to air for the first time, the sensor elements 911-914 will begin to corrode. Each of the sensor elements 911-914 will cease to conduct at various points in time. The point in time that a particular sensor element 911-914 will cease to conduct is determined by the width and thickness of that sensor element 911-914. The code transmitted by the RFID sensor is dependent on the number of sensor elements 911-914 that have corroded through. The code can be converted to a time signature indicating the duration of exposure to the environmental condition.

The foregoing description of the various embodiments of the invention has been presented for the purposes of illustration and description. It is not intended to be exhaustive or to limit the invention to the precise form disclosed. Many modifications and variations are possible in light of the above teaching. For example, embodiments of the present invention may be implemented in a wide variety of applications. It is intended that the scope of the invention be limited not by this detailed description, but rather by the claims appended hereto.

What is claimed is:

1. An RFID-based sensor, comprising:
a plurality of discrete sensor elements, each sensor element configured to change conductivity state based on exposure of the sensor element to a physical condition; and
an RFID circuit coupled to the plurality of sensor elements, the RFID circuit configured to transmit an identification code, the identification code based at least in part on the conductivity state of the plurality of sensor elements.

2. The sensor of claim 1, wherein the identification code indicates a level of exposure to the condition.

3. The sensor of claim 1, wherein the identification code indicates duration of exposure to the condition.

4. The sensor of claim 1, wherein:
each sensor element of the plurality of sensor elements is sensitive to exposure to a distinct condition; and
the identification code indicates exposure to each of the distinct conditions.

5. The sensor of claim 1, wherein the sensor comprises one or more thin film circuit components.

6. The sensor of claim 1, wherein the RFID circuit is powered by AC power.

7. An RFID system, comprising:
a plurality of sensor elements, each sensor element configured to change conductivity state based on exposure of the sensor element to a physical condition;
an RFID circuit coupled to the plurality of sensor elements, an identification code of the RFID circuit based at least in part on the conductivity state of the plurality of sensor elements; and
an RFID interrogator configured to receive the identification code from the RFID circuit.

8. The RFID system of claim 7, wherein the RFID circuit comprises an independent power source.

9. The RFID system of claim 7, wherein the RFID circuit is powered by RF energy transmitted from the RFID interrogator.

10. The RFID system of claim 7, wherein the identification code indicates a level of exposure to the condition.

11. The RFID system of claim 7, wherein the identification code indicates duration of exposure to the condition.

12. A method, comprising:
sensing a conductivity state of a plurality of sensor elements, each sensor element of the plurality of discrete sensor elements configured to change conductivity state based on exposure of the sensor element to a physical condition; and
forming an identification code of an RFID circuit using the sensed conductivity state of the plurality of sensor elements.

13. The method of claim 12, further comprising transmitting the identification code to an RFID reader via the RFID circuit.

14. The method of claim 12, wherein the conductivity state of the plurality of sensor elements indicates a level of exposure to the condition.

15. The method of claim 12, wherein the conductivity state of the plurality of sensor elements indicates a duration of exposure of the plurality of sensor elements to the condition.

16. The method of claim 12, wherein the conductivity state of the plurality of sensor elements indicates exposure of the plurality of sensor elements to a plurality of distinct conditions.

17. The method of claim 12, wherein the conductivity state of the plurality of sensor elements indicates a history of exposure of the plurality of sensor elements to the condition.

18. The method of claim 12, further comprising powering the RFID circuit using an independent power source of the RFID circuit.

19. The method of claim 12, further comprising powering the RFID circuit using RF energy transmitted from an RFID reader.

20. An RFID-based sensor, comprising:
discrete sensor elements, each sensor element configured to switch from a first conductivity state associated with a first binary logic level to a second conductivity state associated with a second binary logic level based on exposure of the sensor element to a physical condition; and
an RFID circuit coupled to the discrete sensor elements, the RFID circuit configured to transmit a binary code corresponding to the conductivity states of the sensor elements.

21. The sensor of claim 20, wherein the code indicates a level of exposure to the condition.

22. The sensor of claim 20, wherein the code indicates duration of exposure to the condition.

23. The sensor of claim 20, wherein:
each of the sensor elements is sensitive to exposure to a distinct condition; and
the code indicates exposure to each of the distinct conditions.

24. The sensor of claim 20, wherein the code indicates a prior exposure to the condition.

25. The sensor of claim 20, wherein the code indicates a present exposure to the condition.

26. The sensor of claim 20, wherein at least one of the sensor elements is configured to change state by an oxidation process.

27. The sensor of claim 20, wherein at least one of the sensor elements is configured to change state by a corrosion process.

28. The sensor of claim 20, wherein at least one of the sensor elements is configured to change state by a mechanical process.

29. The sensor of claim 20, wherein at least one of the sensor elements is configured to change state by a chemical process.

30. The sensor of claim 20, wherein at least one of the sensor elements is configured to change state by a thermal process.

31. The sensor of claim 20, wherein the physical condition is an environmental condition.

32. The sensor of claim 20, wherein the physical condition is associated with exposure to at least one of an electrical field, a magnetic field, and a gravitational field.

33. The sensor of claim 20, further comprising an additional sensor element, the additional sensor element configured to change conductivity due to an action of a human or animal.

34. The sensor of claim 20, wherein the code comprises an identification code of the RFID circuit.
